(19) United States
(12) Patent Application Publication
(10) Pub. No.: US 2013/0059086 A1
(43) Pub. Date: Mar. 7, 2013

(54) METAL-COATED STEEL STRIP

(71) Applicants: Michael Angel Lopez, Dapto Heights (AU); Wayne Andrew Renshaw, Unanderra (AU); Andrew Vincent Micallef, Mornington (AU); Nega Setargew, Figtree (AU); Paul Donaldson, Mount Eliza (AU)

(72) Inventors: Michael Angel Lopez, Dapto Heights (AU); Wayne Andrew Renshaw, Unanderra (AU); Andrew Vincent Micallef, Mornington (AU); Nega Setargew, Figtree (AU); Paul Donaldson, Mount Eliza (AU)

(73) Assignee: BLUESCOPE STEEL LIMITED, Melbourne, Victoria (AU)

(21) Appl. No.: 13/575,100

(22) PCT Filed: Jan. 25, 2011
(86) PCT No.: PCT/AU2011/000069

§ 371 Date: Nov. 13, 2012

(30) Foreign Application Priority Data
Jan. 25, 2010 (AU) 2010900287

(51) Int. Cl. B05D 1/18

(52) U.S. Cl. 427/433

(57) ABSTRACT

A hot dip method of forming an Al—Zn—Si—Mg alloy coating on a strip is disclosed. The method includes controlling the conditions in the molten bath to minimise the top dross layer in the molten bath. In particular, the method includes controlling top dross formation by including Ca and/or Sr in the coating alloy in the bath.

The present invention relates to the production of strip, typically steel strip, which has a corrosion-resistant metal alloy coating that contains aluminium-zinc-silicon-magnesium as the main elements in the alloy, and is hereinafter referred to as an “Al—Zn—Si—Mg alloy” on this basis.

In particular, the present invention relates to a hot-dip metal coating method of forming an Al—Zn—Si—Mg alloy coating on a strip that includes dipping uncoated strip into a bath of molten Al—Zn—Si—Mg alloy and forming a coating of the alloy on the strip.

More particularly, the present invention is concerned with minimising the amount of top dross in the alloy coating bath. Top dross is undesirable from the viewpoints of cost of production and coating quality, as is discussed further below.

Typically, the Al—Zn—Si—Mg alloy of the present invention comprises the following ranges in % by weight of the elements Al, Zn, Si, and Mg:

Al: 40 to 60%

Zn: 30 to 60%

Si: 0.3 to 3%

Mg: 0.3 to 10%

More typically, the Al—Zn—Si—Mg alloy of the present invention comprises the following ranges in % by weight of the elements Al, Zn, Si, and Mg:

Al: 45 to 60%

Zn: 35 to 50%

Si: 1.2 to 2.5%

Mg 1.0 to 3.0%

The Al—Zn—Si—Mg alloy coating may contain other elements that are present as deliberate alloying additions or as unavoidable impurities. Hence, the phrase “Al—Zn—Si—Mg alloy” is understood herein to cover alloys that contain such other elements as deliberate alloying additions or as unavoidable impurities. The other elements may include by way of example any one or more of Fe, Sr, Cr, and V.

Depending on the end-use application, the metal-coated strip may be painted, for example with a polymeric paint, on one or both surfaces of the strip. In this regard, the metal-coated strip may be sold as an end product itself or may have a paint coating applied to one or both surfaces and be sold as a painted end product.

The present invention relates particularly but not exclusively to steel strip that is coated with the above-described Al—Zn—Si—Mg alloy and is optionally coated with a paint and thereafter is cold formed (e.g. by roll forming) into an end-use product, such as building products (e.g. profiled wall and roofing sheets.

One corrosion resistant metal coating composition that is used widely in Australia and elsewhere for building products, particularly profiled wall and roofing sheets, is a 55% Al—Zn coating composition that also comprises Si. The profiled sheets are usually manufactured by cold forming painted, metal alloy coated strip. Typically, the profiled sheets are manufactured by roll-forming the painted strip.

The addition of Mg to this known composition of 55% Al—Zn—Si coating composition has been proposed in the patent literature for a number of years, see for example U.S. Pat. No. 6,635,359 in the name of Nippon Steel Corporation, but Al—Zn—Si—Mg coatings on steel strip are not commercially available in Australia.

It has been established that when Mg is included in a 55% Al—Zn coating composition, Mg brings about certain beneficial effects on product performance, such as improved cut-edge protection.

The applicant has found that Mg-containing molten 55% Al—Zn coating metal is susceptible to increased levels of top dross generation compared to molten 55% Al—Zn coating metal that does not contain Mg.

The term “top dross” is herein understood to include any one or more of the following components on or near the surface of the molten bath:

(a) an oxide film on the surface of a molten bath,

(b) molten metal droplets covered by an oxide film,

(c) gas bubbles having an oxide film as the wall of the bubbles,

(d) intermetallic particles that are formed in the coating bath, including particles covered by an oxide film, and

(e) combinations of any two or more of gas, molten metal, and intermetallic particles covered by an oxide film.

Items (b), (c), (d), and (e) can be described as the result of entrainment of molten metal, gas, and intermetallic particles in the oxide film on or near the surface of the molten bath.

During a line trial to hot-dip metal coat a Mg-containing 55% Al—Zn alloy onto a steel strip that has been conducted by the applicant it was shown that the level of top dross generated in the coating bath was 6 to 8 times that of the top dross formed in a 55% Al—Zn alloy coating bath without Mg addition. Whilst not wishing to be bound by the following comment, the applicant attributes the generation of excessive top dross in Mg-containing molten coating alloys to the reactivity and rapid oxidation of Mg in the alloys and the changes in the properties of the liquid metal (for example, surface tension) that result from the addition of Mg to 55% Al—Zn alloy baths. More particularly, Mg has a higher affinity for oxygen compared with Al and therefore Mg oxidises much more readily than Al. This is evident from the standard free energy of formation (ΔG^{o}) of the oxides which shows that: the thermodynamic driving force for oxide formation is much greater for Mg than for Al (ΔG^{o}_{Al2O3}=934 kJ/mol and ΔG^{o}_{MgO}=−1015 kJ/mol at a bath operating temperature of 600° C.). Moreover, turbulence in the melt surface enhances both the oxidation of molten metal in the bath and the entrainment of the oxide film in the coating bath. The entrainment of the oxide film in the coating bath results in the entrainment of molten metal, gas, and intermetallic particles in the oxide film in the molten bath and the consequential formation of the dross components described in items (b), (c), (d), and (e) above. This top dross has high volume fractions of voids, oxide stringers and dross intermetallic particles entrained in the top dross.

The amount of top dross generated has a significant impact on the cost of production of Mg-containing 55% Al—Zn alloy coated steel. Top dross must be removed from the bath surface periodically to prevent surface defects on the coated steel strip. The removal of top dross represents a cost to the producer of coated steel strip due to the cost of the removal process and the cost of top dross disposal or recycling. Reducing top dross generation provides an opportunity to significantly reduce the cost of production.

In addition, reducing top dross also provides an opportunity to lead to improved surface quality of the coated strip by reducing entrainment of oxide stringers and suspended dross particles.

The above discussion is not to be taken as an admission of the common general knowledge in Australia and elsewhere.

The applicant has been able to reduce the top dross levels in molten Al—Zn—Si—Mg alloy baths by the addition to molten baths of (a) Ca, (b) Sr and (c) Ca and Sr and the reduction in top dross levels has lead to benefits in terms of production costs and product quality. The addition of these elements is hereinafter referred to as the addition of “Ca and/or Sr”. It is noted that the above reference to the addition of Ca and Sr is not intended to indicate that Ca is added before Sr. The present invention extends to situations in which Ca and Sr are added at the same time or at different times to molten baths.

The applicant found that this reduction in top dross generation in molten Al—Zn—Si—Mg alloy baths by the addition of Ca and/or Sr to the baths is due to changes in the entrainment of gas, molten metal and intermetallic particles in oxide films in top dross in the baths resulting from (a) changes to the apparent surface tension at the liquid metal/oxide interface as a result of the Ca and/or Sr addition and (b) changes in the nature of the oxide film as a result of the Ca and/or Sr addition. The changes in the nature of the oxide film reduce the level of oxide stringers formed, which in turn assists in an overall reduction in liquid droplet entrainment.

According to the present invention there is provided a method of forming an Al—Zn—Si—Mg alloy coating on a strip that includes dipping strip into a bath of molten Al—Zn—Si—Mg alloy and forming a coating of the alloy on the strip, with the bath having a molten metal layer and a top dross layer on the metal layer, and the method including controlling the conditions in the molten bath to minimise the top dross layer in the molten bath.

The method may include controlling the conditions in the molten bath to minimise entrainment of any one or more of molten metal, gas, and intermetallic particles in oxide films in the top dross layer.

The conditions in the bath may include the composition of the alloy in the bath.

Hence, the method may include controlling the composition of the bath to minimise the top dross layer in the molten bath, for example by minimising liquid droplet entrainment in oxide films in the top dross layer in the bath.

The method may include controlling the composition of the bath to minimise the top dross layer in the molten bath by including Ca in the composition of the bath.

The composition of the bath may include more than 50 ppm Ca. It is noted that all references to ppm in the specification are references to ppm by weight

It is noted that the reference to amounts of elements such as Ca and Sr as part of the composition of a molten bath are understood herein to be references to the concentrations of the elements in the molten metal layer of the bath as opposed to the top dross layer in the bath. The reason for this is that it is the standard practice of the applicant to measure bath concentrations in the molten metal layers of molten baths.

It is also noted that the applicant found that Ca and Sr tend to segregate to the top dross layer of molten baths and, as a consequence the top dross layer becomes enriched with respect to Ca and Sr when compared to the metal layer. Specifically, if there is “x” wt. % of Ca or Sr in the molten metal layer of a molten bath, there will be a higher concentration of the element in the top dross layer of the bath. For example, the applicant found in laboratory work that in a bath with a nominal bath composition of 90 ppm Ca, the Ca content of the top dross layer increased to 100 ppm Ca. Similarly, the applicant found that in a bath with a nominal composition of 400 ppm Ca, the top dross layer was enriched substantially to 600 ppm. Similar enrichments were also observed for Sr in laboratory work. For example, in a bath with a nominal composition of 500 ppm Sr, after 3 hrs of processing the top dross layer was enriched in Sr to 700 ppm. And in a bath with a nominal composition of 750 ppm Sr, after 3 hrs of processing the top dross layer was enriched to 1100 ppm Sr. In practice, this means that, if it is required that there be “x” wt. % of Ca or Sr in the molten metal layer of a molten bath, it will be necessary to add an amount of Ca or Sr that is greater than “x” wt. % in the total bath to compensate for the higher concentration of Ca or Sr that will segregate to the top dross layer.

The composition of the bath may include more than 150 ppm Ca.

The composition of the bath may include more than 200 ppm Ca.

The composition of the bath may include less than 1000 ppm Ca.

The composition of the bath may include less than 750 ppm Ca.

The composition of the bath may include less than 500 ppm Ca.

The Ca may be added to the bath as required. It could be by way of specific additions of Ca compounds on a continuous or a periodic basis. It could also be by way of the inclusion of Ca in Al and/or Zn ingots that are provided as feed materials for the bath.

The method may include controlling the composition of the bath to minimise the top dross layer in the molten bath by including Sr in the composition of the bath.

The composition of the bath may include more than 100 ppm Sr.

The composition of the bath may include more than 150 ppm Sr.

The composition of the bath may include more than 200 ppm Sr.

The composition of the bath may include less than 1250 ppm Sr.

The composition of the bath may include less than 1000 ppm Sr.

The Sr may be added to the bath as required. It could be by way of specific additions of Sr compounds on a continuous or a periodic basis. It could also be by way of the inclusion of Sr in Al and/or Zn ingots that are provided as feed materials for the bath.

The method may include controlling the composition of the bath to minimise the top dross layer in the molten bath by including Ca and Sr in the composition of the bath.

The amounts of Ca and Sr in the composition may be as described above, with adjustments to the amounts of each element to compensate for the effect of an addition of the other element on the top dross layer.

The method may include controlling the composition of the bath to minimise the top dross layer in the molten bath by including rare earth elements such as yttrium and a combination of rare earths and Ca and/or Sr in the composition of the bath.

The method may include controlling the composition of the bath to minimise the top dross layer in the bath by periodically monitoring the concentration of any one or more of Ca, Sr, and rare earth elements that are in the bath, and adding Ca, Sr, and rare earth elements as required to maintain the bath composition for the element or elements.

In a situation in which the Ca, Sr, and rare earth elements are part of ingots of other elements that are in the composition in the bath, the method may include selecting any one or more of the sizes of the ingots, the timing of the addition of the ingots, and the sequence of the addition of the ingots to maintain the concentration of Ca, Sr, and rare earth elements substantially constant or within a preferred range of + or −10% for the elements.

The Al—Zn—Si—Mg alloy may comprise more than 0.3% by weight Mg.

The Al—Zn—Si—Mg alloy may comprise more than 1.0% by weight Mg.

The Al—Zn—Si—Mg alloy may comprise more than 1.3% by weight Mg.

The Al—Zn—Si—Mg alloy may comprise more than 1.5% by weight Mg.

The Al—Zn—Si—Mg alloy may comprise less than 3% by weight Mg.

The Al—Zn—Si—Mg alloy may comprise more than 2.5% by weight Mg.

The Al—Zn—Si—Mg alloy may comprise more than 1.2% by weight Si.

The Al—Zn—Si—Mg alloy may comprise the following ranges in % by weight of the elements Al, Zn, Si, and Mg:

Al: 40 to 60%

Zn: 30 to 60%

Si: 0.3 to 3%

Mg: 0.3 to 10%

In particular, the Al—Zn—Si—Mg alloy may comprise the following ranges in % by weight of the elements Al, Zn, Si, and Mg:

Al: 45 to 60%

Zn: 35 to 50%

Si: 1.2 to 2.5%

Mg 1.0 to 3.0%

According to the present invention there is also provided an Al—Zn—Si—Mg alloy coating on a strip produced by the above-described method.

The present invention is described further by way of example with reference to the accompanying drawings of which:

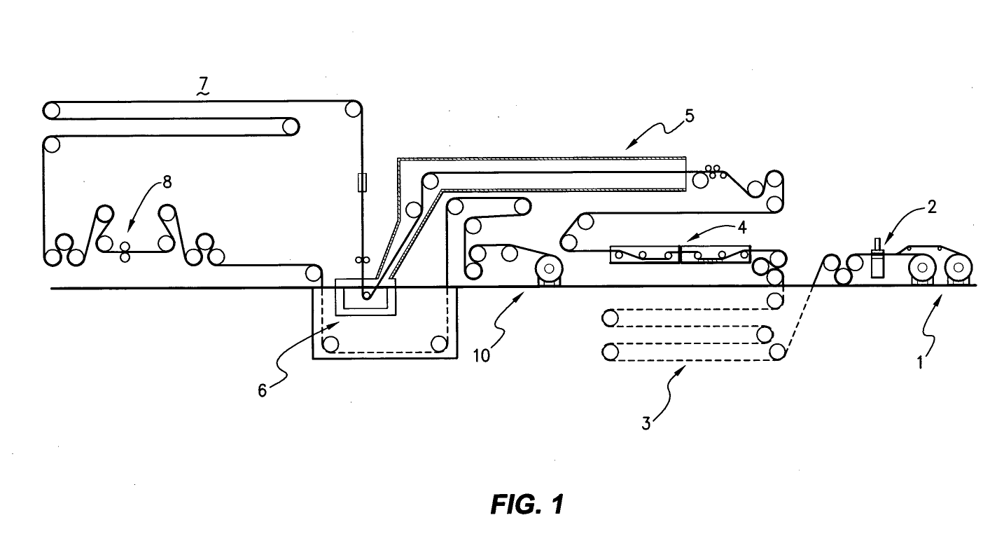

FIG. 1 is a schematic drawing of one embodiment of a continuous production line for producing steel strip coated with an Al—Zn—Si—Mg alloy in accordance with the method of the present invention;

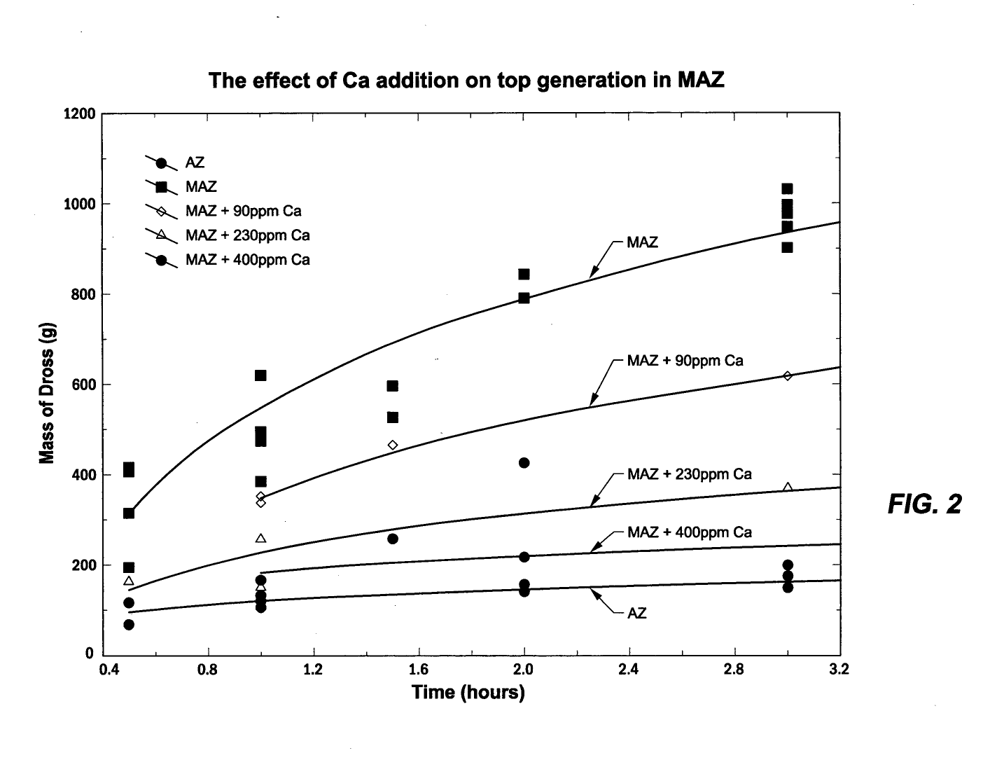

FIG. 2 is a graph of the mass of dross versus time for molten Al—Zn—Si alloy baths with and without Mg and with and without Ca in experiments on dross generation carried out by the applicant;

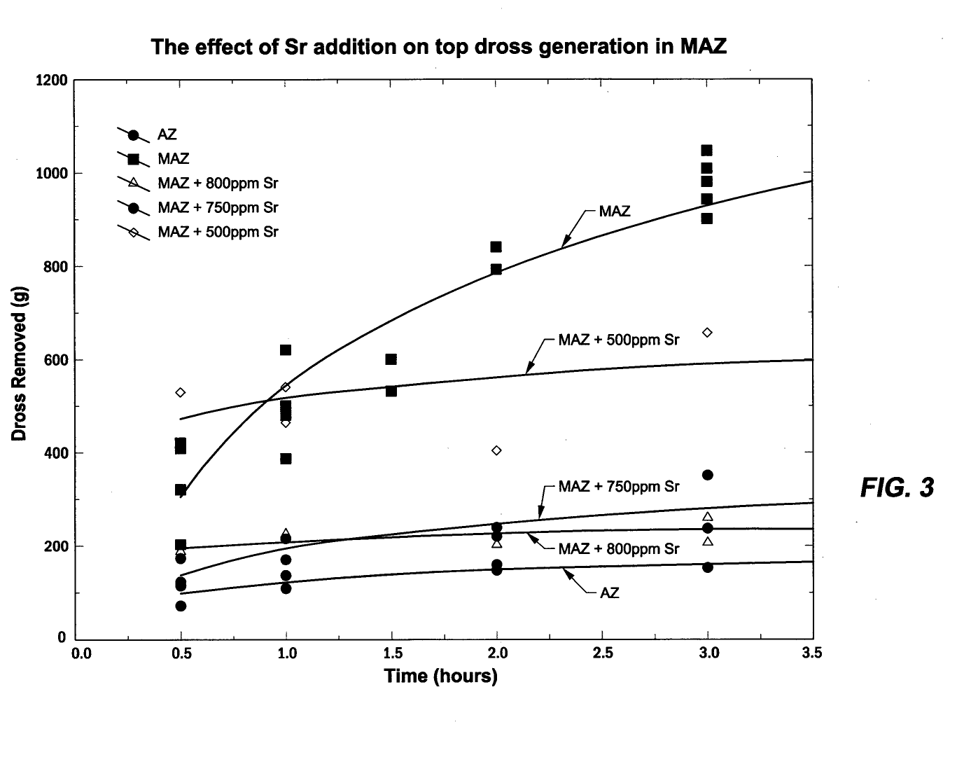

FIG. 3 is a graph of the mass of dross versus time for molten Al—Zn—Si alloy baths with and without Mg and with and without Sr in experiments on dross generation carried out by the applicant;

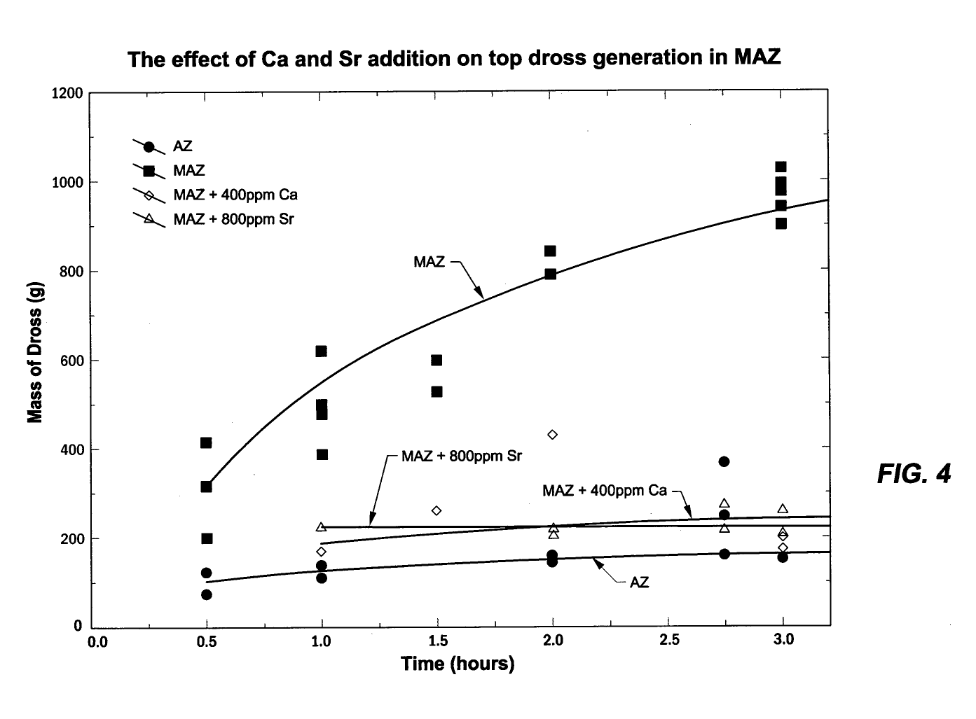

FIG. 4 presents selected results from the experimental work summarised in FIGS. 2 and 3 that highlights the impact of Ca and Sr on top dross generation;

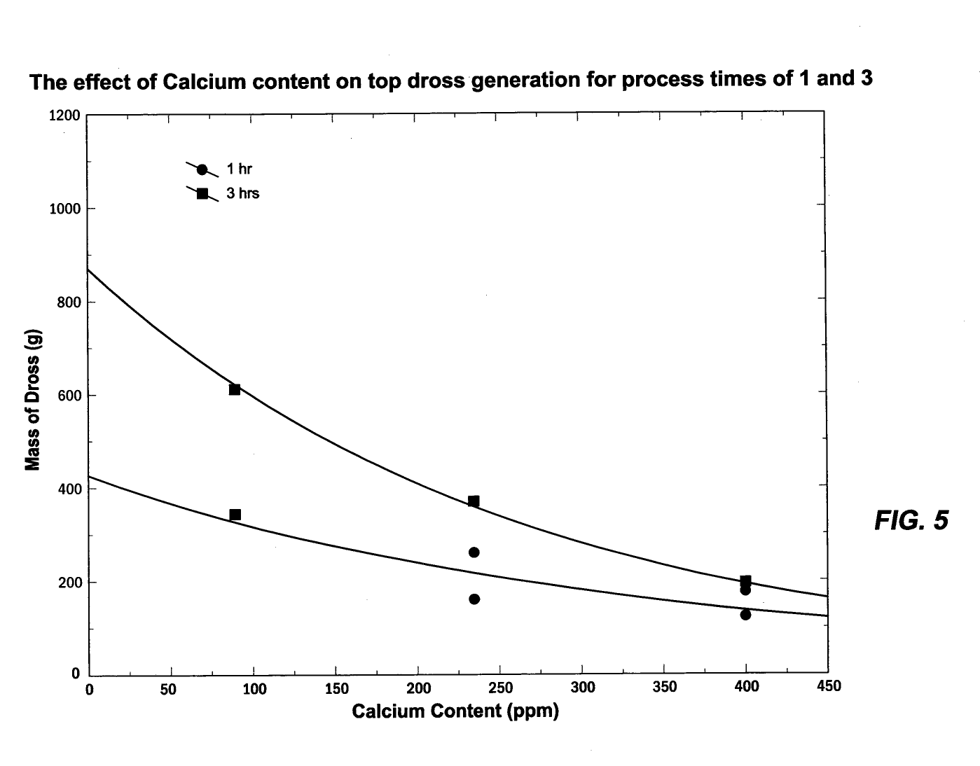

FIG. 5 is a graph of the mass of dross versus Ca content in Al—Zn—Si—Mg alloy baths after process times of 1 and 3 hours; and

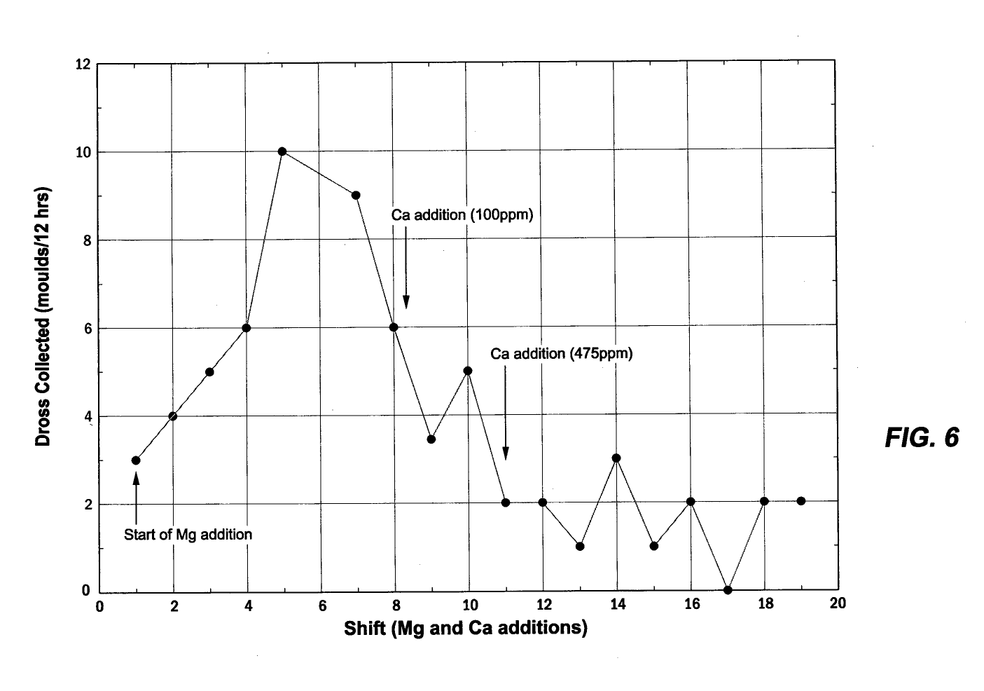

FIG. 6 is a graph of the mass of dross generated versus time during the course of a line trial carried out by the applicant.

With reference to FIG. 1, in use, coils of cold rolled steel strip are uncoiled at an uncoiling station 1 and successive uncoiled lengths of strip are welded end to end by a welder 2 and form a continuous length of strip.

The strip is then passed successively through an accumulator 3, a strip cleaning section 4 and a furnace assembly 5. The furnace assembly 5 includes a preheater, a preheat reducing furnace, and a reducing furnace.

The strip is heat treated in the furnace assembly 5 by careful control of process variables including: (i) the temperature profile in the furnaces, (ii) the reducing gas concentration in the furnaces, (iii) the gas flow rate through the furnaces, and (iv) strip residence time in the furnaces (i.e. line speed).

The process variables in the furnace assembly 5 are controlled so that there is removal of iron oxide residues from the surface of the strip and removal of residual oils and iron fines from the surface of the strip.

The heat treated strip is then passed via an outlet snout downwardly into and through a molten bath containing an Al—Zn—Si—Mg alloy held in a coating pot 6 and is coated with Al—Zn—Si—Mg alloy. The Al—Zn—Si—Mg alloy is maintained molten in the coating pot by use of heating inductors (not shown). Within the bath the strip passes around a sink roll and is taken upwardly out of the bath. Both surfaces of the strip are coated with the Al—Zn—Si—Mg alloy as it passes through the bath.

After leaving the coating bath 6 the strip passes vertically through a gas wiping station (not shown) at which its coated surfaces are subjected to jets of wiping gas to control the thickness of the coating.

The coated strip is then passed through a cooling section 7 and subjected to forced cooling.

The cooled, coated strip is then passed through a rolling section 8 that conditions the surface of the coated strip.

The coated strip is thereafter coiled at a coiling station 10.

As is indicated above, the applicant has found that Al—Zn—Si—Mg alloy coating baths generate substantially greater amounts of top dross in the baths than is the case with conventional 55% Al—Zn alloy baths in the coating lines of the applicant.

As discussed above, the applicant has conducted a number of laboratory experiments and line trials to determine whether it is possible to reduce the amount of dross generated in an Al—Zn—Si—Mg alloy bath. As discussed above, the applicant found that it was possible to significantly reduce the level of top dross by the addition of Ca or Sr to Al—Zn—Si—Mg alloys in coating baths.

The experimental results on the effect of Ca and Sr additions to coating baths on the level of top dross generation in Al—Zn—Si—Mg alloy coating baths are summarized in FIGS. 2 to 5.

The experimental work was carried out on the following alloy compositions, in wt. % for (a) an Al—Zn alloy (referred to as “AZ” in the Figures) and (b) an Al—Zn—Mg alloy (referred to as “MAZ” in the Figures) and (c) these AZ and MAZ alloys plus parts per million (ppm) Ca and Sr additions to these compositions:

### AZ: 55Al-43Zn-1.5Si-0.5Fe

### MAZ: 53Al-43Zn-2Mg-1.5Si-0.5Fe

### MAZ+236 ppm Ca.

### MAZ+90 ppm Ca.

### MAZ+400 ppm Ca.

### MAZ+500 ppm Sr.

### MAZ+750 ppm Sr.

### MAZ+800 ppm Sr.

It is noted that the concentrations of Ca and Sr are the concentrations of these elements in the metallic parts of molten baths.

In the experimental work the top dross generation was simulated using a laboratory melting furnace and an overhead mechanical stirrer. The laboratory set-up consisted of the following components:
A melting furnace with clay graphite crucible.
A variable speed overhead mechanical stirrer with a support stand.
Dross collector cup machined from high density sintered boron-nitride ceramic and having a series of drainage holes in the bottom of the cup and a series of upstanding handles to allow the cup to be positioned and removed from the crucible.
Stainless steel impellor shaft.
Impellor machined from high density sintered boron nitride ceramic.

The dross collector cup and the impellor were fabricated from a high temperature material that is non-wetting to molten AZ and MAZ alloys. The sintered boron nitride ceramic of these components provided excellent non-wetting characteristics and high temperature stability in the coating bath.

For each experiment, 15 kg of the coating alloy of a required composition was formed in the crucible and held at the process temperature of 600° C. The dross collector cup was then inserted into the molten bath and was retained in the bath until the melt temperature reached the process temperature. Then the shaft impellor assembly was lowered into the bath until the impellor just touched the surface of the melt. The stirrer motor was then switched on and the stirring speed was adjusted to 60 RPM. This experimental set-up resulted in shearing of the surface of the bath without creating a vortex so that at each revolution of the impellor a fresh melt was continuously exposed to air to generate dross. The dross generated was pushed to the side of the crucible and accumulated on the side of the crucible. At the end of each experiment the accumulated dross was removed from the crucible by lifting the dross collector cup from the crucible and allowing excess entrained bath metal to drain into the crucible via holes in the dross collector cup. What was left in the dross collector cup comprised the entrained bath metal and dross intermetallic particles covered with oxide film. This retained material was the top dross generated in each experiment.

The experiments were conducted for durations of 0.5, 1.2, and 3 hrs.

After each experiment the dross collected was removed and weighed and the results are plotted as shown in FIGS. 2 to 5.

FIGS. 2 to 4 are graphs of the mass of dross versus time for the molten alloy baths, with the FIG. 2 results focusing on the results for the Ca alloys and the FIG. 3 results focusing on the results for the Sr alloys and the FIG. 4 results highlighting selected results for Ca and Sr from FIGS. 2 and 3.

FIG. 5 is a graph of the mass of dross versus Ca content in molten alloy baths after process times of 1 and 3 hours.

FIGS. 2 to 5 clearly show that the level of top dross generated in an Al—Zn—Si—Mg alloy bath can be significantly reduced by additions of Ca or Sr to MAZ alloy coating baths. More particularly, FIGS. 2 to 5 show that:

(a) MAZ alloy coating baths generate significantly higher amounts of top dross that AZ alloy coating baths, and

(b) the amount of top dross decreases significantly with increasing amounts of Ca and Sr in the MAZ alloys.

The results shown in FIGS. 2 to 5 were further confirmed for Ca in a line trial conducted for approximately 2 weeks. The line trial was carried out on the above-mentioned AZ alloy to which Mg and Ca were added at different points in time during the course of the line trial. FIG. 6 shows the dross collected during the line trial and that the results are consistent with what was observed in the laboratory work. In particular, FIG. 6 shows that there was a substantial increase in the amount of dross generated in the molten bath with the addition of Mg to the bath and a substantial decrease in the amount of dross as a consequence of the addition of Ca to the bath.

As is indicated above, the applicant attributes the reduction in the dross level to reduction in the entrainment of molten metal, gas, and intermetallic particles in the oxide film in the molten bath (i.e. in the top dross layer in the bath) that resulted from (a) changes to the apparent surface tension at the liquid metal/oxide interface as a result of the Ca and Sr additions and (b) changes in the nature of the oxide film as a result of the Ca and Sr additions. The changes in the nature of the oxide film reduced the level of oxide stringers formed, which in turn assists in an overall reduction in liquid droplet entrainment. The changes in the entrainment lead to reductions in the level of top dross generation in molten Al—Zn—Si—Mg alloys.

Ca and Sr are examples of elements that can be added to a molten bath of an Al—Zn—Si—Mg alloy to reduce the entrainment of molten metal, gas, and intermetallic particles in the oxide film in the bath and thereby reduce the level of dross in the bath. Other bath additions include, by way of example, rare earth elements such as yttrium and combinations of rare earths and calcium and strontium and calcium/strontium.

In practice, the Ca and/or Sr may be added to the bath as required. It could be by way of specific additions of Ca and/or Sr compounds on a continuous or a periodic basis. It could also be by way of the inclusion of Ca and/or in Al and/or Zn ingots that are provided as feed materials for the bath.

Many modifications may be made to the present invention described above without departing from the spirit and scope of the invention.

1-24. (canceled)

25. A method of forming an Al—Zn—Si—Mg alloy coating on a strip that includes dipping the strip into a bath of molten Al—Zn—Si—Mg alloy and forming a coating of the alloy on the strip, with the bath having a molten metal layer and a top dross layer on the metal layer, and the method including controlling conditions in the molten bath to minimize the top dross layer in the molten bath by controlling the composition of the bath to include more than 200 ppm Ca.

26. The method defined in claim 25 including controlling the conditions in the molten bath to minimize the top dross layer in the molten bath by controlling the conditions in the molten bath to minimize entrainment of any one or more of molten metal, gas, and intermetallic particles in oxide films in the top dross layer.

27. The method defined in claim 25 including controlling the composition of the bath to include less than 1000 ppm Ca.

28. The method defined in claim 25 including controlling the composition of the bath to include less than 750 ppm Ca.

29. The method defined in claim 25 including controlling the composition of the bath to include less than 500 ppm Ca.

30. The method defined in claim 25 including controlling the composition of the bath to minimize the top dross layer in the molten bath by including Sr in the composition of the bath.

31. The method defined in claim 30 including controlling the composition of the bath to include more than 100 ppm Sr.

32. The method defined in claim 30 including controlling the composition of the bath to include more than 150 ppm Sr.

33. The method defined in claim 30 including controlling the composition of the bath to include more than 200 ppm Sr.

34. The method defined in claim 30 including controlling the composition of the bath to include less than 1250 ppm Sr.

35. The method defined in claim 30 including controlling the composition of the bath to include less than 1000 ppm Sr.

36. The method defined in claim 25 including controlling the composition of the bath to minimize the top dross layer in the molten bath by including rare earth elements such as yttrium and combinations of rare earths and Ca and/or Sr in the composition of the bath.

37. The method defined in any claim 25 wherein the Al—Zn—Si—Mg alloy comprises more than 0.3% by weight Mg.

38. The method defined in claim 25 wherein the Al—Zn—Si—Mg alloy comprises more than 1.0% by weight Mg.

39. The method defined in claim 25 wherein the Al—Zn—Si—Mg alloy comprises less than 3% by weight Mg.

40. The method defined in claim 25 wherein the Al—Zn—Si—Mg alloy comprises more than 1.2% by weight Si.

41. The method defined in claim 25 wherein the Al—Zn—Si—Mg alloy comprises the following ranges in % by weight of the elements Al, Zn, Si, and Mg:
Al: 40 to 60%
Zn: 30 to 60%
Si: 0.3 to 3%
Mg: 0.3 to 10%

42. The method defined in claim 25 wherein the Al—Zn—Si—Mg alloy comprises the following ranges in % by weight of the elements Al, Zn, Si, and Mg:
Al: 45 to 60%
Zn: 35 to 50%
Si: 1.2 to 2.5%
Mg 1.0 to 3.0%
